(19) United States
(12) Patent Application Publication
(10) Pub. No.: US 2019/0336994 A1
(43) Pub. Date: Nov. 7, 2019

(54) SPRINKLER HEAD WITH DAMPER MOTOR

(71) Applicants: DON DUFFIN, PAUL, ID (US); ROGER DUFFIN, PAUL, ID (US)

(72) Inventors: DON DUFFIN, PAUL, ID (US); ROGER DUFFIN, PAUL, ID (US)

(21) Appl. No.: 16/404,635

(22) Filed: May 6, 2019

Related U.S. Application Data
(60) Provisional application No. 62/627,053, filed on May 4, 2018.

(51) Int. Cl. B05B 3/04; A01G 25/02; B05B 15/74; A01G 25/16

(52) U.S. Cl. CPC B05B 3/0486; A01G 25/165; B05B 15/74; A01G 25/02

(57) ABSTRACT

What is disclosed is a sprinkler head having a nozzle configured for spraying a fluid, such as irrigation water, at a distribution disk. The distribution disk is configured to rotate on an upper axle. The upper axle is housed within an upper axle housing. The upper axle housing is configured to rotate about a lower axle. The dual axle provides for two different rotation axles of the distribution disk in operation. Preferably a speed control device can be positioned to control the speed of rotation of one axle or both axles.

### PRIORITY/CROSS-REFERENCE TO RELATED APPLICATIONS

This application claims the benefit of U.S. Provisional Application No. 62/627,053, filed May 4, 2018, the disclosure of which is incorporated by reference.

### TECHNICAL FIELD

The herein disclosed and claimed inventive concept(s) generally relates to a sprinkler head, and more particularly to a sprinkler head utilizing a distribution disc for randomizing fluid distribution.

### BACKGROUND

Various sprinkler heads have been utilized to distribute irrigation water. What is needed is a sprinkler head that provides for increased functionality and control.

### BRIEF DESCRIPTION OF THE FIGURES

FIG. 1 is a side view of a first preferred embodiment of a sprinkler head.

FIG. 2 is a cutaway view of a first preferred embodiment of a sprinkler head.

FIG. 3 is a perspective view of a first preferred embodiment of a sprinkler head.

FIG. 4 is a side view of a first preferred embodiment of a sprinkler head.

FIG. 5 is a cutaway view of a second preferred embodiment of a sprinkler head.

FIG. 6 is a partial cutaway perspective view of a second preferred embodiment of a sprinkler head.

FIG. 7A is a cutaway perspective view of a second preferred embodiment of a sprinkler head.

FIG. 7B is a perspective view of a second preferred embodiment of a sprinkler head as shown in FIG. 7A.

FIG. 8 is a side view of a second preferred embodiment of a sprinkler head.

FIG. 9 is a cutaway view of a third preferred embodiment of a sprinkler head.

FIG. 10 is a partial cutaway perspective view of a third preferred embodiment of a sprinkler head.

FIG. 11 is a side view of a third preferred embodiment of a sprinkler head.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

Disclosed is a sprinkler head which uses two axles for providing rotation of a distribution disk configured to distribute fluid, such as irrigation water, sprayed from a nozzle at the distribution disk. The sprinkler head can use dampeners with one axle or both axles to control the speed of rotation of that axle or about that axle. The sprinkler head utilizes a distribution disk affixed to an upper axle, but allows for rotation, whether in a circular rotation, a nutating rotation, or a random rotation. Preferably the sprinkler head utilizes geared teeth associated with the distribution disk, axle, and/or axle housing to provide a controlled path of rotation of the distribution disk. The geared teeth are configured to interact with a series of geared teeth positioned within the sprinkler housing. Alternatively two series of geared projections can be utilized in association with the distribution disk, axle and/or axle housing and the sprinkler body to provide further control of the rotation of the distribution disk.

The sprinkler has a fluid delivery tube which extends through the sprinkler disk, and is directed at a distribution plate. In a preferred embodiment the sprinkler disk has on its periphery a number of projections which form gear teeth. Corresponding gear teeth on the distribution disk periphery engage the gear teeth on the sprinkler disk, and direct the path of the rotation of the distribution disk.

In a preferred embodiment the distribution disk is set at a fixed angle so the gear teeth on the distribution plate and the gear teeth on the sprinkler disk engage as the distribution disk rotates around the lower axle. The lower axle is positioned within a housing that is supported by one or more support is which are attached to the sprinkler disk. The sprinkler disk and arms are commonly referred to herein as the sprinkler housing. In a preferred embodiment, an upper axle housing is set at an angle from the lower axle and secures the distribution disk. In a preferred embodiment due to the angle that the upper axle housing holds the distribution disk to the sprinkler disk, the distribution disk both rotates and nutates in a fixed trajectory. In an alternative preferred embodiment the distribution disk and upper axle are configured to provide rotation of the distribution disk without nutation. In this preferred embodiment the upper axle and lower axle are generally oriented in parallel. In a further preferred embodiment the upper axle housing and the lower axle can be configured such that the upper axle housing rotates about the lower axle to cause nutation of the distribution disk. As used herein when rotation is discussed about and axle the axle can rotate with the object rotating, or the object rotation can rotate freely of the axle and not deviate from the scope of the invention.

An axle extends from the distribution disk through a speed control hub, which contains a viscous fluid which controls the speed of rotation of the axle, and thus the speed of rotation of the distribution disk. The distribution disk has a raised center peak, which contains spiral grooves which guide water from the distribution disk. Water encounters the distribution disk from the deliver tube, and imparts a rotary force which causes the distribution disk to rotate, and the angle set by the upper axle housing imparts a nutating motion to the rotation. The speed control hub slows the speed of rotation of the distribution disk on the axle. Alternatively the speed control can be positioned within the upper axle housing such that the speed of rotation of the upper axle housing around its pivot axle (or pivot pin). In a further embodiment both the rotation of the upper axle housing as well as the nutation of the distribution disk can be controlled by speed control devices.

Also disclosed is an embodiment of the sprinkler which has the distribution disk set at a fixed angle to the delivery tube, and internal gears which cause the distribution disk to rotate around the water delivery tube. The spiral grooves impart a rotary force to the distribution disk, and the center peak of the distribution disk extends past the tip of the delivery tube, so centering of the distribution disk is prevented. This embodiment includes a pivot pin, a speed control hub with a viscous dampening fluid, and an axle on which the distribution disk rotates. The angle of the distribution disk to the delivery tube is constant, and constrained in speed by the speed control hub.

A third embodiment is disclosed which has a speed control hub on an axle, with the distribution disk attached to a upper axle. The upper axle has a range of tilt which allows the distribution disk to face the delivery tube at different angles as it rotates and nutates around the delivery tube. Geared teeth in the sprinkler body engage a lower gear wheel attached to or integrated with the lower axle housing to direct the rotation of upper axle housing it rotates on the lower axle. A second set of geared teeth is provided in association with the distribution disk and configured to interact with geared teeth positioned on or integral with an internal surface of the sprinkler housing to control rotation of the distribution disk.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### Detailed Description of the Exemplary Embodiments

While the presently disclosed technology is susceptible of various modifications and alternative constructions, certain illustrated embodiments thereof have been shown in the drawings and will be described below in detail. It should be understood, however, that there is no intention to limit the claimed technology to the specific form disclosed, but, on the contrary, the presently disclosed and claimed technology is to cover all modifications, alternative constructions, and equivalents falling within the spirit and scope of the inventive concept(s) as defined in the claims. The use of the term “upper” and “lower” refer to the orientation shown in the figures and are not to be construed as limiting in the event of rotation of a device. The term fluid is used generically herein to define a fluid flow of which can be distributed by a sprinkler head, including but not limited to irrigation water.

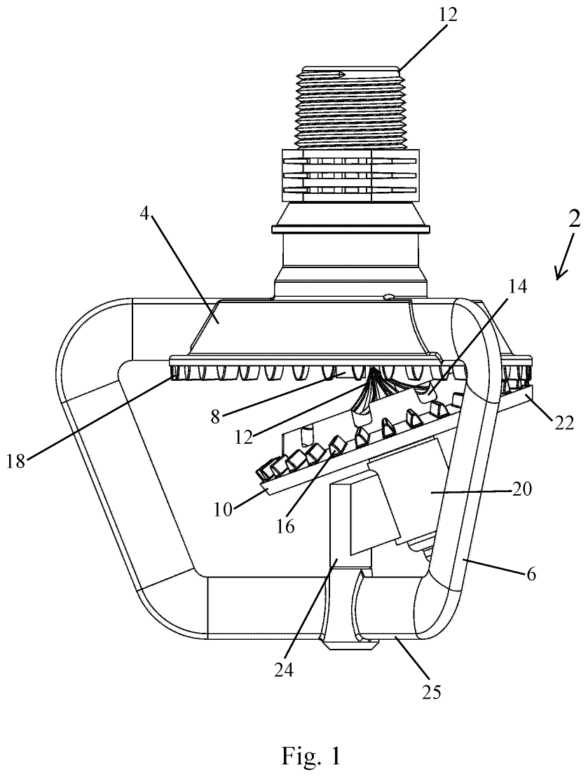

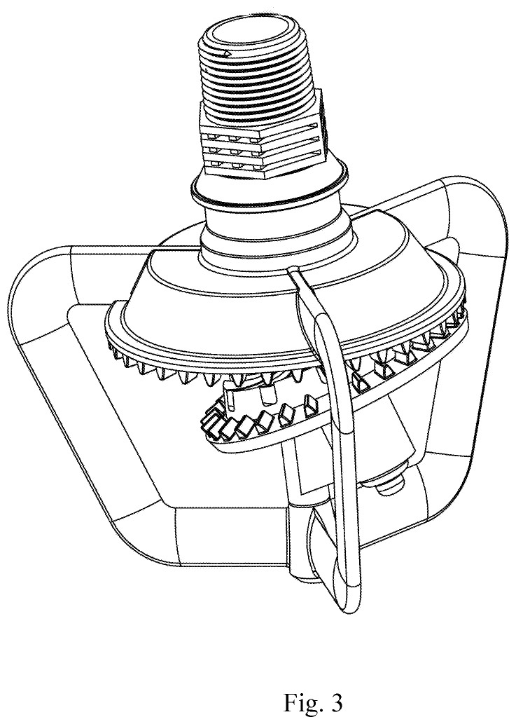

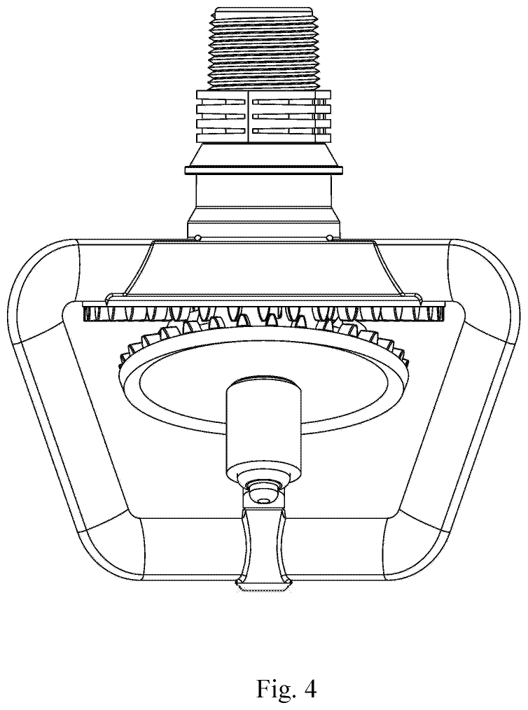

FIGS. 1 through 4 depict a first preferred embodiment of the inventive concepts disclosed herein. The sprinkler head 2 is depicted utilizing a sprinkler disc 4 utilizing one or more support arms 6 configured to support a rotation arm and distribution disk. The sprinkler head is configured to attach to a source line such as by a threaded connector 12 configured for mating attachment to a source line. The sprinkler head is configured with a nozzle (not shown in FIG. 1) in connection with a distribution tube 8 that are configured to direct flow of fluid, such as water, onto a distribution disk 10. The distribution disk is configured with an apex 12 and a series spirally radiating grooves 14 that are configured to distribute fluid sprayed on the distribution disk. The distribution disk is configured to rotate with the upper axle housing as well as to rotate independently of the upper axle housing via two axles, one attached to the distribution disk and housed within the upper axle housing and the second or lower axle 28 connecting the upper axle housing to the lower sprinkler support 25, which can be a single arm 6 or be comprised of multiple support arms as depicted. The distribution disk is configured to rotate on an axle, this position within an axel has a 20 and preferred embodiment the axle has a 20 and speed control unit. To control the rotation of the distribution disk.

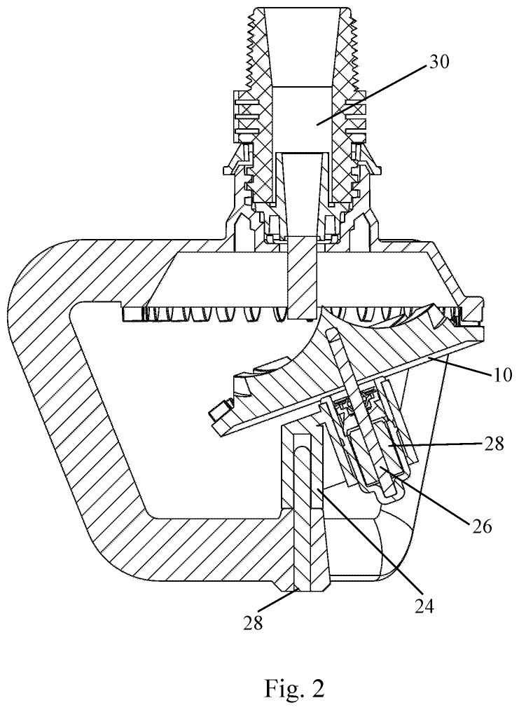

The upper axle housing 24 is configured to rotate about a lower axle 28, shown in FIG. 2. FIG. 2 further shows a distribution nozzle 30 within the sprinkler body configured for controlling the spray of water toward the distribution disk. The sprinkler head is configured such that when the upper axle housing and distribution disk rotate around the sprinkler head, geared teeth positioned 16 on the distribution disk are configured to engage with gear teeth 18 on the sprinkler disk to direct the path of rotation of the distribution plate at the uppermost portion 22 of the nutating disk.

In a preferred embodiment either or both of the axles 26, 28 can utilize a braking mechanism 28, such as a viscous or magnetic brake, to control the speed of rotation of either the distribution disk or the upper axle housing.

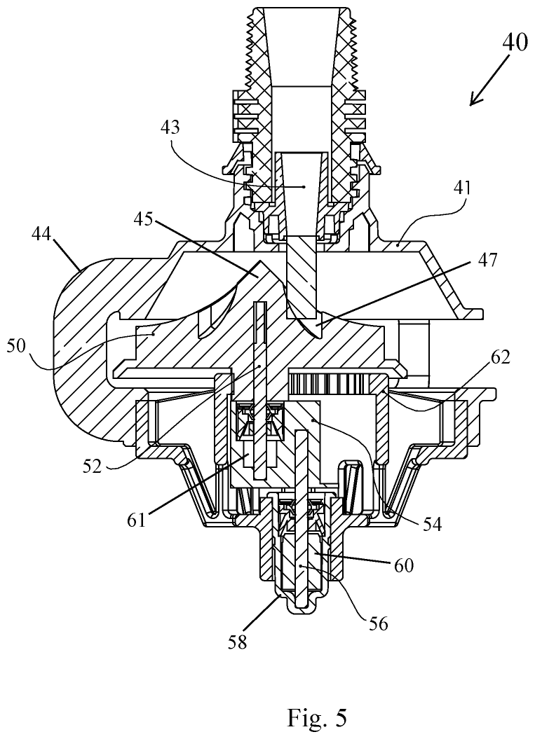

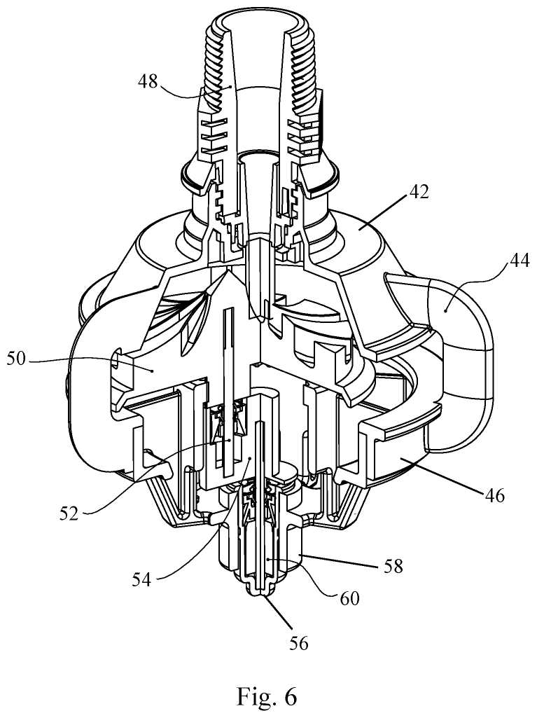

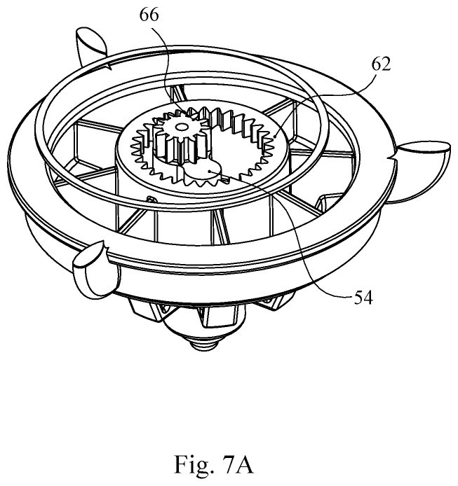

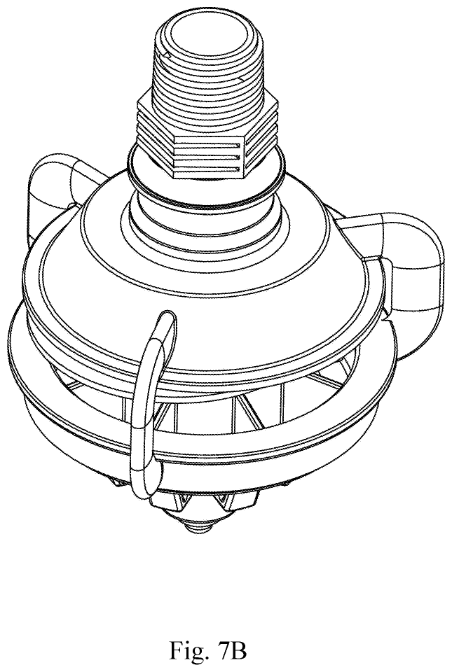

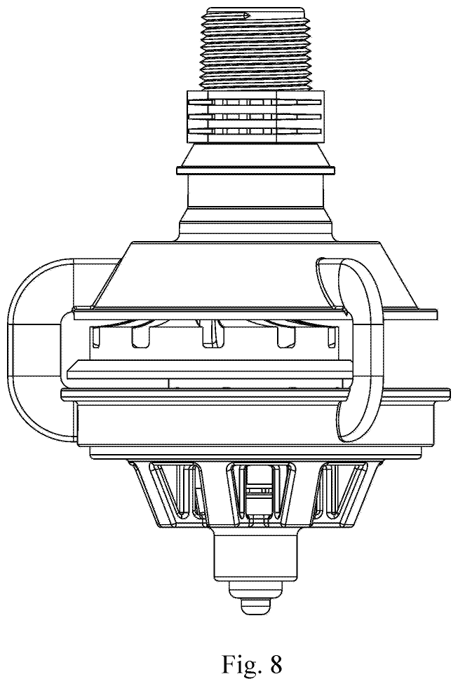

FIGS. 5 thru 9 depict the second preferred embodiment of a sprinkler head utilizing a dual axle rotation control. The sprinkler head has a housing 1 that utilizes one or more support arms 44 to support a water distribution control. The distribution disk has a apex 45 and a series of valleys and ridges 47 that serve to direct fluid sprayed onto the distribution disk. The distribution control utilizes a distribution disk 50 mounted on an upper axle 52. The upper axle is configured to rotate in an upper axle housing 54. The upper axle housing is connected to a lower axle 56 positioned within a lower axle housing 58. Either or both of the upper axle housing and the lower axle housing can utilize speed control mechanisms 60, 61 to control the rotation speed of the distribution disk or the rotation speed of the upper axle housing. The sprinkler housing 62 has gear teeth that are configured to interact with a series of gear teeth positioned as an integral part of the distributor, or as a separate or integral bushing 66 having gear teeth as shown in FIG. 7. The depicted embodiment in FIG. 5 through 9 illustrate three support arms between the upper sprinkler housing and the lower sprinkler housing, although any number can be utilized without deviating from the scope of the invention disclosed herein.

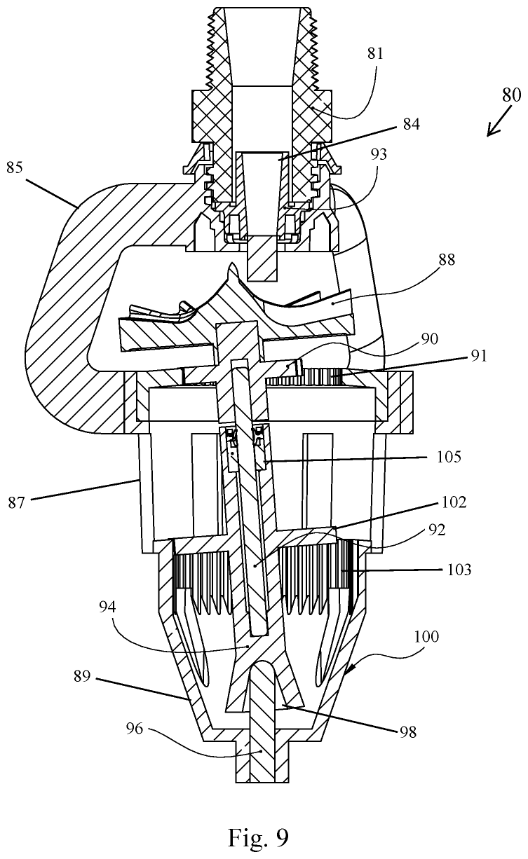

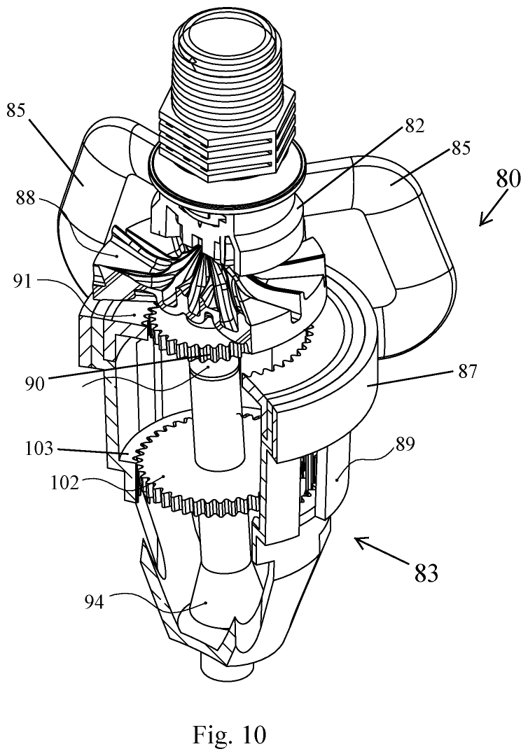

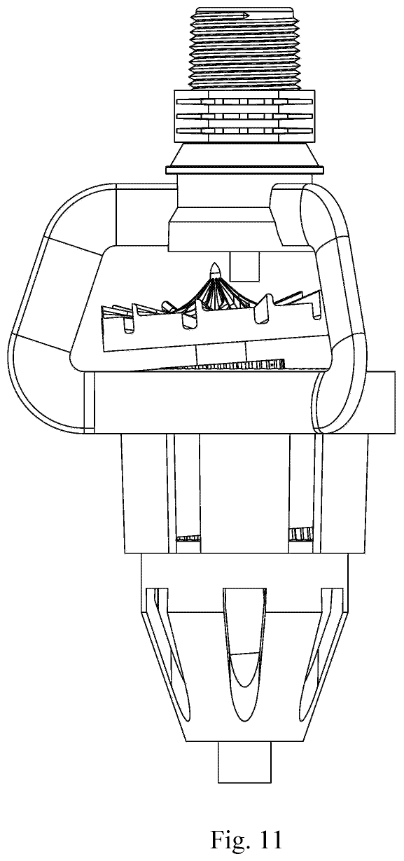

FIGS. 9 through 11 illustrated a third preferred embodiment of a sprinkler head utilizing two axles to control the rotation of a fluid distribution disk. The depicted sprinkler head utilizes a nozzle 84 housed within a sprinkler body 93 that is configured to spray a stream of fluid at a distribution disk 88. The distribution disk rotates on an upper axle 102. The upper axle rotates within an axle shaft 94. In the depicted embodiment the distribution disk is connected to the upper axle via a bushing 90 that has geared teeth positioned around the circumference of the bushing.

The teeth of the bushing are configured to interact with teeth 91 found in the upper gear housing 87 of the sprinkler body 100 to direct the rotation of the distribution disk. The upper axle 92 is positioned within the upper axle housing 89. The upper axle housing is configured to rotate about a lower axle 96 when fluid is sprayed onto the distribution disk from the nozzle. The upper axle housing further has a disk 102 having a series of geared teeth that are configured to engage the series of geared teeth 103 in the lower gear housing 89. The upper gear housing 87 and/or gear housing 89 make up the motor gear housing 83. The motor housing 85 is supported by one or more arms 85. This configuration allows the distributor disk to spin while allowing it to rotate about the lower axle.

The upper axle housing also has a void or opening 98 configured for a receiving the lower axle 98 or pin. As depicted, the upper axle housing is configured to rotate about the lower axle 96 to provide a nutation like movement to the distributor disk when fluid is sprayed on the distribution disk from the nozzle.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A sprinkler head comprising:
a sprinkler housing comprising a fluid intake,
a nozzle configured to direct said fluid from said intake,
a distribution disk, wherein said distribution disk is configured to rotate in response to fluid directed onto said distribution disk from said nozzle,
an upper axle attached to said distribution disk, wherein said upper axle is configured to rotate within an upper axle housing;
a lower axle attached to said upper axle housing, wherein said upper axle housing is configured to rotate on said lower axle.

2. The sprinkler head of claim 1, wherein said distribution disk comprises geared teeth configured to interact with geared teeth of said sprinkler housing to control rotation of said distribution disk

3. The sprinkler head of claim 1, wherein said upper axle and said lower axle comprise a parallel orientation.

4. The sprinkler head of claim 1, wherein at least one of said upper axle and said lower axle comprises a braking mechanism.

5. The sprinkler head of claim 1, wherein said upper axle and said lower axle are configured such that said distribution disk nutates in response to fluid directed at said distribution disk from said nozzle.

6. The sprinkler head of claim 1, wherein said first axle comprises a bushing configured to rotate with said distribution disk, wherein said bushing comprises geared teeth configured on a circumference of said bushing, wherein said geared teeth are configured to interact with geared teeth on said sprinkler housing to direct rotation of said distribution disk and bushing.

7. The sprinkler head of claim 6, wherein said bushing is integral with said distribution disk.

8. The sprinkler head of claim 5, wherein said upper axle housing is angled to provide said nutation.

9. The sprinkler head of claim 5, wherein said upper axle is configured to rotate on said lower axle to cause nutation of said distribution plate within said housing.

10. The sprinkler head of claim 1, wherein said upper axle housing comprises a circumference defining a series of gear teeth, wherein said gear teeth are configured to interact with a series of gear teeth on an inner surface of said sprinkler housing.

11. The sprinkler head of claim 1, wherein said distribution disk comprises a generally peaked surface having an apex, said surface incised by spirally radiating grooves.
